(19) United States
(12) Patent Application Publication
(10) Pub. No.: US 2008/0061079 A1
(43) Pub. Date: Mar. 13, 2008

(54) METHOD AND APPARATUS FOR FLUID PROPORTIONING

(75) Inventor: Tom Hedger, Renton, WA (US)

Correspondence Address: LARSON AND LARSON, 11199 69TH STREET NORTH, LARGO, FL, 33773, US

(73) Assignee: GRAVES SPRAY SUPPLY, INC., Clearwater, FL (US)

(21) Appl. No.: 11/530,657

(22) Filed: Sep. 11, 2006

(51) Int. Cl. B67D 5/08; B67D 5/52

(52) U.S. Cl. 222/63; 222/135

(57) ABSTRACT

An apparatus for dispensing plural component materials under pressure having at least a first and a second component and a desired ratio between the components is disclosed. The apparatus includes at least a first and a second pump, each of the pumps has an outlet and an inlet connected to one of the components. Each of the pumps has a driver connected by a shaft to drive the pumps and a sensor coupled to the shaft. Each of the sensors output a signal relational to a volume being pumped by the driver-pump set to which the sensor is connected. There is at least a first and a second fluid regulator each with an input, an output and a control; each input is attached to the outlet of one of the pumps. The outputs of the fluid regulators are connected to a mixing manifold for mixing the component materials. A controller electrically coupled to the sensors determines the output of each pump and adjusts the output ratio of the components to approximate the desired ratio by controlling each of the fluid regulators.

### BACKGROUND OF THE INVENTION

1. Field of the Invention

This invention relates to the field of pressurizing components and more particularly to a method, system and apparatus for pressurizing and mixing two or more components in a fixed ratio.

2. Description of the Related Art

Devices exist in the art to pressurize and precisely mix components such as paints and resins. Often, it is important to precisely control the ratio of the components in the output. A low technology method of mixing such materials is commonly known as hot potting. In hot potting, the user merely pours the desired amounts of the two (or more) components into a container, mixes them and then sprays or otherwise applies the material. In addition to the mess involved in preparing and mixing, this process often results in inaccurate mixing and wasted material as often the total amount of material mixed is not utilized. Furthermore, depending upon the time lag between the mixing and the application steps, some of the materials may settle, providing an uneven application.

One solution to this problem is described in U.S. Pat. No. 6,896,152 to Pittman, et al, which is hereby incorporated by reference. In this patent, a system is described that pumps, pressurizes, proportions, and dispenses plural component paints and other materials. Individual material components (typically resin, catalyst and reducer) are supplied to simple reciprocating piston pumps through siphon hoses. The operation of the piston pumps are electronically and pneumatically controlled to pressurize and provide flow of the materials at the selected ratio through hoses attached to a mix manifold fluid pressure regulator. The materials combine at the mix manifold and pass through a length of hose to integrate the materials. A static mixer is used to thoroughly integrate and mix the materials. The mixed material is then dispensed from a spray gun. Unfortunately, the disclosed device can only supply a limited range of ratios. The patent indicates that ratios can range from 1:1(:1) to 8:1(:1) (the number in parenthesis is for the optional third component. For components currently used in the industry, this range of ratios is not sufficient.

What is needed is a system, method and apparatus that will accurately pressurize, proportion and mix two or more components.

### SUMMARY OF THE INVENTION

In one embodiment, an apparatus for dispensing plural component materials under pressure having at least a first and a second component and a desired ratio between the components is disclosed. The apparatus includes at least a first and a second pump, each of the pumps has an outlet and an inlet connected to one of the components. Each of the pumps has a driver connected by a shaft to drive the pumps and a sensor coupled to the shaft. Each of the sensors output a signal relational to a volume being pumped by the driver-pump set to which the sensor is connected. There is at least a first and a second fluid regulator each with an input, an output and a control; each input is attached to the outlet of one of the pumps. The outputs of the fluid regulators are connected to a mixing manifold for mixing the component materials. A controller electrically coupled to the sensors determines the output volume of each pump and adjusts the output ratio of the components to approximate the desired ratio by controlling each of the fluid regulators.

In another embodiment, a method of dispensing plural component materials under pressure is disclosed. There is at least a first and a second component and a desired ratio between the components. Also included is a first pump continuously pumping the first component and a second pump continuously pumping the second component. The method is performed by a computer and includes inputting the desired ratio and storing the desired ratio in the computer's memory then outputting a fully-operative voltage (e.g., full-on) by the computer to a first fluid regulator associated with the first pump. Next, a partial-operative voltage based upon the desired ratio is determined and the partial-operative voltage is outputted to a second fluid regulator associated with the second pump. For a period of time, the computer counts the number of cycles of the first pump and the number of cycles of the second pump. Afterwards, the computer determines the current ratio by dividing the count of the number of cycles of the second pump by the count of the number of cycles of the first pump. If the current ratio is greater than the desired ratio, the computer reduces the partial-operative voltage and outputs the partial-operative voltage to the second fluid regulator. If the current ratio is less than the desired ratio, the computer increases the partial-operative voltage and outputs the partial-operative voltage to the second fluid regulator.

In another embodiment, an apparatus for dispensing plural component materials under pressure is disclosed. There is a first and a second component and a desired ratio between the components. The apparatus includes a first pump with an outlet and an inlet connected to the first component and a second pump with an outlet and having an inlet connected to the second component. A first driver is connected by a first shaft to the first pump and a second driver is connected by a second shaft to the second pump means. A first sensor is coupled to the first shaft and outputs a signal relational to a volume being pumped by the first pump while a second sensor is coupled to the second shaft and outputs a signal relational to a volume being pumped by the second pump. A first fluid regulator has an input attached to the outlet of the first pump, an output and a control. A second fluid regulator has an input attached to the outlet of the second pump, an output and a control. There is a mixing manifold connected to the output of the first fluid regulator and the output of the second fluid regulator for mixing the component materials. A controller is electrically coupled to the first and the second sensors and determines the output of each pump and accordingly adjusts an output ratio of the components to approximate the desired ratio by controlling each of the fluid regulators.

In another embodiment, an apparatus for dispensing plural component materials under pressure is disclosed. There is a first and a second component and a desired ratio between the components. The apparatus includes a first and a second pump, each of the pumps having an outlet and an inlet connected to one of the components. A first driver is connected by a first shaft to the first pump forming a first driver-pump set and a second driver is connected by a second shaft to the second pump forming a second driver-pump set. A first sensor is coupled to the first driver-pump set and a second sensor coupled to the second driver-pump set, each of the sensors outputting a signal relational to a volume being pumped by the driver-pump set to which the sensor is connected. A fluid regulator has an input attached to the outlet of the first pump and also has an output and a control. The output is connected to a first input of a mix manifold. A second input of the mix manifold is connected to the output of the second pump, the mix manifold for mixing the component materials. Finally, there is a controller electrically coupled to the sensors and adapted to determine an output volume of each pump, adjusting the output ratio of the components to approximate the desired ratio by controlling the fluid regulator.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a system of a first embodiment of the present invention.

FIG. 2 illustrates a schematic view of a system of a second embodiment of the present invention.

FIG. 3 illustrates a flow chart of the present invention.

FIG. 4 illustrates a schematic view of an exemplary programmable microcontroller of the present invention.

FIG. 5 illustrates a schematic view of a system of a third embodiment of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

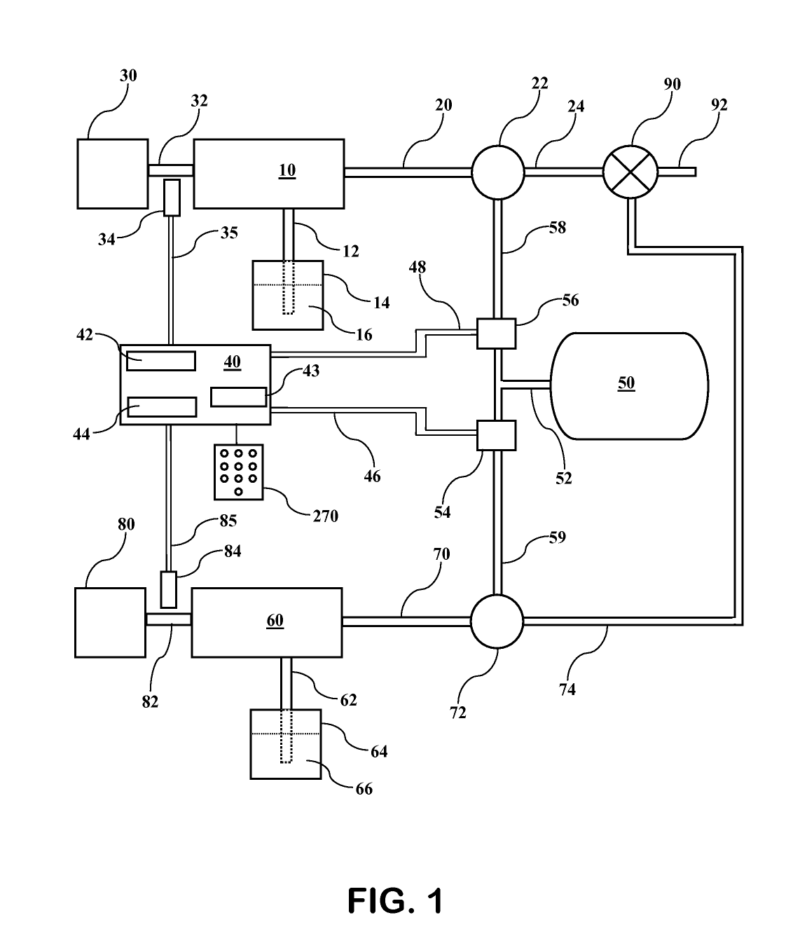

Referring to FIG. 1, a schematic view of a system of the present invention is shown. In this, two pumps 10/60 are shown, although in other embodiments, more than two pumps are used. Each pump 10/60 is coupled to a source of motion (e.g., a motor or driver) 30/80. In some embodiments, the pumps 10/60 are reciprocating pumps and the source of motion 30/80 provides reciprocating motion by way of shafts 32/82. In some embodiments, the pumps 10/60 are rotational pumps and the source of motion 30/80 provides rotational motion by way of shafts 32/82. One set of pumps 10/60, shafts 32/82 and sources of motion 30/80 is considered a pump-set.

Sensors 34/84 are interfaced to the pumps 10/60, shafts 32/82 or sources of motion 30/80. The sensors generate a number of pulses proportional to the movement of the shafts 32/82, thereby generating a signal indicative of the amount of component pressurized by their respective pump 30/80. There are many such sensors known in the art. Some use magnets and reed-relays or coils to sense the movement of the shafts 32/82. Some use a light source and light detector along with an interrupter coupled to the shafts 32/82, whereby as the shaft turns, the light beam is interrupted by the interrupter one or more times per revolution. Other examples of sensors that work equally as well are pneumatic proximity sensors and electronic proximity sensors. Although such sensors are capable of generating a wide range of pulses per revolution (from 1 pulse per revolution to over 100 pulses per revolution), it is preferred that the range be from 4 to 20 pulses per revolution.

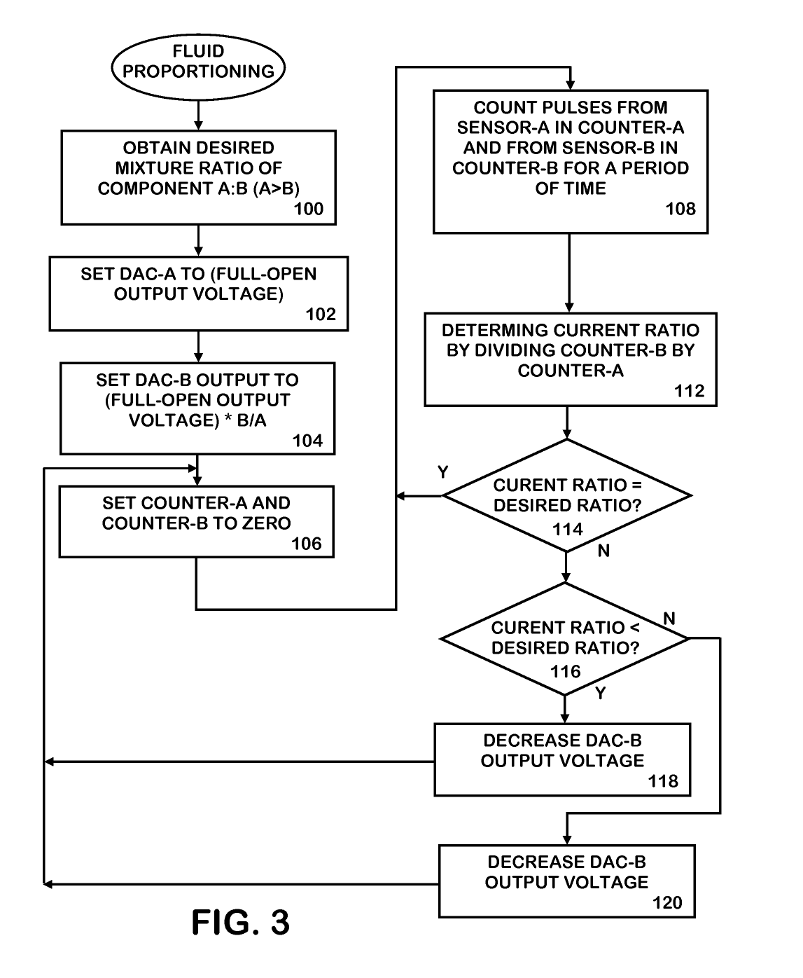

The output signals 35/85 of the sensors 34/84 are interfaced to a controller 40. The controller 40 is a programmable logic controller (PLC) as known in the industry such as a programmable microcontroller or other processor based controller. An exemplary controller is shown in FIG. 3. The controller 40 detects the pulses coming from the sensors 34/84 and counts them with internal counters 42/44 as known in the industry. The ratio of the counters 42/44 is compared to a preset desired ratio 43 and, the output signals 46/48 from the controller 40 are adjusted accordingly. The desired ratio is entered by an operator on a keyboard or keypad 270.

The electrical output signals 46/48 from the controller 40 adjust the air pressure output of air pressure modulators 56/54. The air pressure modulators 56/54 have inputs 52 from a standard source of air pressure 50 which is, for example, an air pressure distribution system within a factory or an air compressor and air storage tank. The outputs of the air pressure modulators 56/54 are proportional to the electrical signals 46/48 coming from the controller 40.

The air pressure output from the air pressure modulators 56/54 is coupled to fluid regulators 22/72 through air pressure conduit 58/59. The fluid regulators 22/72 adjust the flow of the components 16/66 being pumped out of reservoirs 14/64 through siphon tubes 12/62. The components 16/66 are pumped by pumps 10/60 through pressure tubes 20/70 to the fluid regulators 22/72. The fluid regulators 22/72 adjust the amount of components 16/66 that pass through to the output tubes 24/74 and eventually mix in a manifold 90 and are outputted to pressure tube 92 to a nozzle, sprayer or other output device (not shown).

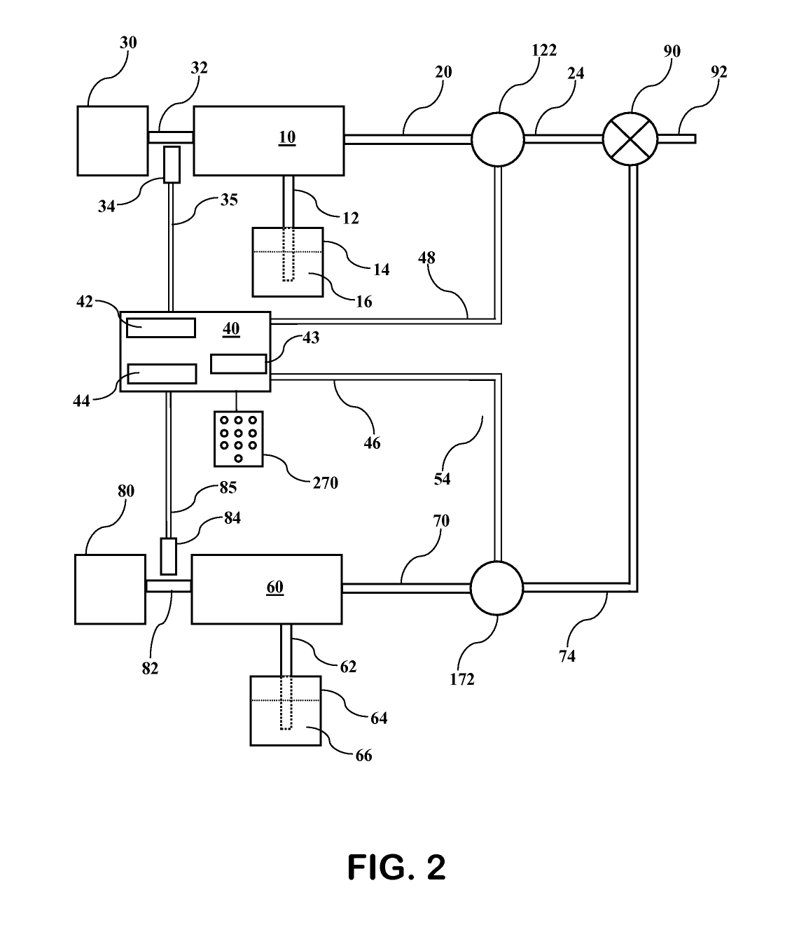

Referring now to FIG. 2, the operation of the system will be described. In this, two pumps 10/60 are shown, although in other embodiments, more than two pumps are used. Each pump 10/60 is coupled to a source of motion 30/80. In some embodiments, the pumps 10/60 are reciprocating pumps and the source of motion 30/80 provides reciprocating motion by way of shafts 32/82. In some embodiments, the pumps 10/60 are rotational pumps and the source of motion 30/80 provides rotational motion by way of shafts 32/82.

Sensors 34/84 are interfaced to the pumps 10/60, shafts 32/82 or sources of motion 30/80. The sensors generate a signal proportional to the movement of the pumps 10/60, thereby generating a signal indicative of the amount of component pressurized by their respective pump 30/80. There are many such sensors known in the art. Some use magnets and reed-relays or coils to sense the movement of the shafts 32/82. Some use a light source and light detector along with an interrupter coupled to the shafts 32/82, whereby as the shaft turns, the light beam is interrupted by the interrupter one or more times per revolution. Other examples of sensors that work equally as well are pneumatic proximity sensors and electronic proximity sensors. Although such sensors are capable of generating a wide range of pulses per revolution (from 1 pulse per revolution to over 100 pulses per revolution), it is preferred that the range be from 4 to 20 pulses per revolution.

The output signals 35/85 of the sensors 34/84 are interfaced to a controller 40. The controller 40 is a programmable controller as known in the industry such as a programmable microcontroller or other processor based, an example of which is shown in FIG. 3. The controller 40 detects the signals coming from the sensors 34/84 and counts them with internal counters 42/44 as known in the industry. The ratio of the counters 42/44 is compared to a preset desired ratio 43 and, the output signals 46/48 from the controller 40 are adjusted accordingly. Again, the desired ratio is entered by an operator on a keypad or keyboard 270.

In this embodiment, the electrical output signals 46/48 from the controller 40 are coupled directly to fluid regulators 122/172. The fluid regulators 122/172 adjust the flow of the components 16/66 being pumped out of reservoirs 14/64 through siphon tubes 12/62. The components 16/66 are pumped by pumps 10/60 through pressure tubes 20/70 to the fluid regulators 22/72. The fluid regulators 122/172 adjust the amount of components 16/66 that pass through to the output tubes 24/74 and eventually mix in a manifold 90 and are outputted on pressure tube 92 to a nozzle, sprayer or other output device (not shown).

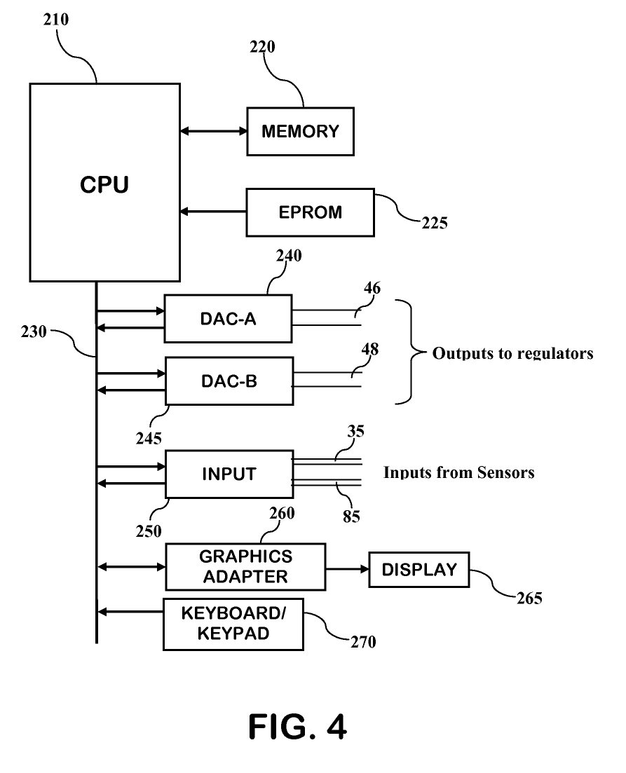

Referring now to FIG. 3, a first flow chart of the fluid proportioning system of the present invention will be described. Before anything can be done, a desired ratio of components A:B must be obtained 100. The desired ratio can be entered in any way known in the industry, including, for example, entering it on a keypad or keyboard (See FIG. 4, 270). For simplicity, it is assumed that A is greater than B. The present invention works equally as well if B is greater than or equal to A with minor modifications to the math. Once the desired ratio is obtained, the first Digital-to-Analog Converter (DAC-A) 240 is controlled to output a maximum voltage 102 representing full flow though the first regulator 22. This voltage is the voltage (or current) required to control the regulator such that the regulator is fully open, allowing the component through. In some examples, this “full-on” voltage is 5VDC, 10VDC, 12VDC, 12VDC, −5VDC, 0VDC, etc.

Next, the second DAC (DAC-B) 245 is controlled to output a voltage proportional to the desired ratio to the second regulator 72. In this example, it is controlled to output a voltage of approximately B divided by A times the maximum voltage 104. This equation assumes that the regulator operates in a linear fashion, e.g., if 10VDC is “full-on,” 5VDC is ½ open and 2.5VDC is ¼ open. This output voltage partially opens the second regulator 72, thereby outputting a lesser amount of the second component 66 than the first component 16. Next, two counters, Counter-A and Counter-B are set to zero 106 and pulses from each of the first sensor 34 and second sensor 84 are counted for a period of time in Counter-A and Counter-B respectively 108. These pulses are, for example, counted by counting the number of interrupts caused by inputs 35/85 or by a program loop that constantly checks for transitions of inputs 35/85 or by any other way known in the industry. This step 108 is performed for a fixed amount of time, after which the current output ratio is determined by dividing Counter-B by Counter-A 112. If the current output ratio is equal to the desired ratio 114, the above three steps are repeated. If not, if the current output ratio is less than the desired ratio 116, the second DAC (DAC-B) output voltage is decreased 118, thereby decreasing the rate of flow though the second regulator 72 and decreasing the proportion of the second component 66 in the output 92 and the process continues by resetting the counters 106. Otherwise, the current output ratio is greater than the desired ratio and the second DAC (DAC-B) output voltage is increased 120, thereby increasing the rate of flow though the second regulator 72 and increasing the proportion of the second component 66 in the output 92 and the process continues by resetting the counters 106. As stated before, if B is greater than A, the same process works by reversing the roles of DAC-A 240 and DAC-B 245, whereby DAC-B 245 is set to full output voltage and DAC-A 240 is controlled proportionally.

Referring now to FIG. 4, an exemplary programmable microcontroller of the present invention will be described. In this exemplary controller 40, a processor 210 is provided to execute stored programs that are normally executed within a memory 220 or EPROM 225. The processor 210 can be any processor, for example an Intel® 8051 processor. The memory 220 is connected to the processor and can be any memory suitable for connection with the selected processor 210, such as SRAM, DRAM, SDRAM, RDRAM, DDR, DDR-2, etc. Firmware is stored in firmware storage 225 that is connected to the processor 210 and may include initialization software. The firmware storage 225 is preferably EPROM storage. In alternate embodiments, the firmware storage 225 is any or multiple of EPROM, EEPROM, PROM, FRAM, ROM or the like. This initialization software usually operates when power is applied to the system or when the system is reset.

Also connected to the processor 210 is a system bus 230 for connecting to peripheral subsystems such as digital analog converters (DAC-A 240 and DAC-B 245 in this example), input receivers 250, an optional graphics adapter or display controller 260 for displaying user prompts and status and an input device such as a keyboard, keypad, thumbwheel switches or potentiometer 270. Any known method for inputting the desired ratio can be used as an input device 270 to the controller 40. The graphics adapter 260 receives commands and display information from the system bus 230 and generates a display image that is displayed on the display 265. The display can be a graphics display or text display such as a dot-matrix display or an array of numeric or alphanumeric displays as known in the industry.

The digital to analog converters 240/245 provide an output voltage 46/48 that is controlled by the processor 210. In the present invention, the output voltage is directed to control the rate of flow from the pumps 10/60.

The input system 250 accepts input signals from the sensors 34/84 on its inputs 35/65 and lets the executing program determine the number of rotations of the pumps 10/16 either by polling the input or by interrupting the running program, as known in the industry.

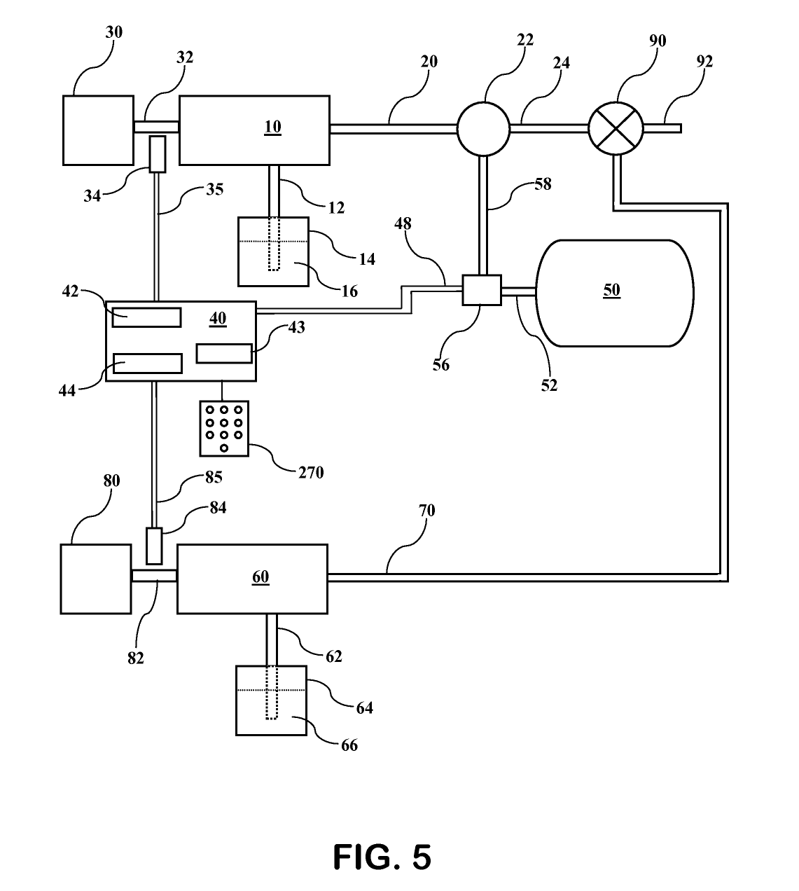

Referring now to FIG. 5, a schematic view of a system of a third embodiment of the present invention is shown. In this, two pumps 10/60 are shown, although in other embodiments, more than two pumps are used. Each pump 10/60 is coupled to a source of motion (e.g., a motor or driver) 30/80. In some embodiments, the pumps 10/60 are reciprocating pumps and the source of motion 30/80 provides reciprocating motion by way of shafts 32/82. In some embodiments, the pumps 10/60 are rotational pumps and the source of motion 30/80 provides rotational motion by way of shafts 32/82. One set of pumps 10/60, shafts 32/82 and sources of motion 30/80 is considered a pump-set.

Sensors 34/84 are interfaced to the pumps 10/60, shafts 32/82 or sources of motion 30/80, although in some embodiments sensor 84 is omitted. The sensors generate a number of pulses proportional to the movement of the shafts 32/82, thereby generating a signal indicative of the amount of component pressurized by their respective pump 30/80. There are many such sensors known in the art. Some use magnets and reed-relays or coils to sense the movement of the shafts 32/82. Some use a light source and light detector along with an interrupter coupled to the shafts 32/82, whereby as the shaft turns, the light beam is interrupted by the interrupter one or more times per revolution. Other examples of sensors that work equally as well are pneumatic proximity sensors and electronic proximity sensors. Although such sensors are capable of generating a wide range of pulses per revolution (from 1 pulse per revolution to over 100 pulses per revolution), it is preferred that the range be from 4 to 20 pulses per revolution.

The output signals 35/85 of the sensors 34/84 are interfaced to a controller 40. The controller 40 is a programmable logic controller (PLC) as known in the industry such as a programmable microcontroller or other processor based controller. An exemplary controller is shown in FIG. 3. The controller 40 detects the pulses coming from the sensors 34/84 and counts them with internal counters 42/44 as known in the industry. The ratio of the counters 42/44 is compared to a preset desired ratio 43 and, the output signal 48 from the controller 40 is adjusted accordingly. The desired ratio is entered by an operator on a keyboard or keypad 270.

The electrical output signal 48 from the controller 40 adjusts the air pressure output of an air pressure modulator 56. The air pressure modulators 56 has an input 52 from a standard source of air pressure 50 which is, for example, an air pressure distribution system within a factory or an air compressor and air storage tank. The output 58 of the air pressure modulator 56 is proportional to the electrical signal 48 coming from the controller 40.

The air pressure output from the air pressure modulators 56 is coupled to a fluid regulator 22 through air pressure conduit 58. The fluid regulators 22 adjust the flow of the component 16 being pumped out of the reservoir 14 through a siphon tube 12. The components 16/66 are pumped by pumps 10/60 through pressure tubes 20/70. The second component 66 is pumped unregulated while the first component 16 is regulated by the fluid regulator 22. The fluid regulator 22 adjusts the amount of the first components 16 that pass through to the output tube 24 and eventually mix in a manifold 90 and outputted to pressure tube 92 to a nozzle, sprayer or other output device (not shown). In this embodiment, the ratio of components 16/66 must be such that the first component 16 is proportionately less than the second component 66, being that the second component 66 always flows at a rate of 100%. Therefore, the sample algorithms described in FIG. 3 would work in a similar manner, except there would be only one DAC to control to adjust the proportions. The step of setting the second DAC to fully open the second valve is not necessary, since there is no second valve. This embodiment is fully extendable by adding additional fluid regulators, air pressure valves, pump sets, sensors, and additional inputs and outputs to the controller 40. Furthermore, this embodiment works equally well with electrically controlled fluid regulators as in the second embodiment.

The above description is for the fluid proportioning of two components 16/66. The described system is scalable to any number of fluid components by providing additional pump systems, sensors and regulators. In most cases, the same controller provided with additional inputs and analog outputs can monitor several sensors while controlling several regulators. There are many methods of providing analog outputs from a controller and all are versions of converting digital to analog; or digital-to-analog converters. There are many sensors known that provide outputs relational to the number of turns or cycles of a pumping system and, likewise, many ways for a controller to monitor these sensors. The sensors and monitor described are an example of such.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An apparatus for dispensing plural component materials under pressure having at least a first and a second component and a desired ratio between the components, the apparatus comprising:
at least a first and a second pump, each of the pumps having an outlet and having an inlet connected to one of the components;
a first and a second driver, each driver being connected by a shaft to drive one of the pumps, each of the pumps, shaft and driver forming a driver-pump set;
a sensor coupled to each of the driver-pump sets, each of the sensors outputting a signal relational to a volume being pumped by the driver-pump set to which the sensor is connected;
at least a first and a second fluid regulator each having an input, an output and a control, each input attached to the outlet of one of the pumps;
a mix manifold connected to the fluid regulator outputs of the fluid regulators for mixing the component materials;
a controller electrically coupled to the sensors, the controller adapted to determine an output volume of each pump and adapted to adjust an output ratio of the components to approximate the desired ratio by controlling each of the fluid regulators.

2. The apparatus for dispensing plural component materials of claim 1, wherein the controller counts pulses from the sensors to determine the output volume of each pump.

3. The apparatus for dispensing plural component materials of claim 1, wherein each sensor generates one or more pulses per stroke of the pump to which it is coupled.

4. The apparatus for dispensing plural component materials of claim 1, wherein the controller is electrically coupled to each of the fluid regulators.

5. The apparatus for dispensing plural component materials of claim 1, wherein the controller is electrically coupled to control one or more air pressure modulators, each air pressure modulator having an input coupled to a source of air pressure and an output coupled to one of the fluid regulators for controlling the fluid regulator.

6. The apparatus for dispensing plural component materials of claim 1, wherein each of the sensors includes at least one magnet affixed to one of the shafts and an induction coil electrically coupled to the controller, the inductor coil in proximity to a travel path of the at least one magnet.

7. The apparatus for dispensing plural component materials of claim 1, wherein each of the sensors includes at least one optical interrupter coupled to one of the shafts, a light source and a photo detector, the photo detector electrically coupled to the controller, the light source aiming at the photo detector and the interrupter passing between the light source and the photo detector so as to interrupt the light and generate an output pulse each time the interrupter passes between the light source and the photo detector.

8. The apparatus for dispensing plural component materials of claim 1, wherein the sensors are selected from the group consisting of pneumatic proximity sensors and electronic proximity sensors.

9. A method of dispensing plural component materials under pressure having at least a first and a second component and a desired ratio between the components, a first pump continuously pumping the first component and a second pump continuously pumping the second component, the method performed by a computer, the method comprising:
(a) inputting the desired ratio and storing the desired ratio in the computer;
(b) outputting a fully-operative voltage by the computer to a first fluid regulator associated with the first pump;
(c) determining a partial-operative voltage based upon the desired ratio and outputting the partial-operative voltage to a second fluid regulator associated with the second pump;
(d) for a period of time, the computer counting a number of cycles of the first pump and the computer counting a number of cycles of the second pump;
(e) the computer determining a current ratio by dividing the number of cycles of the second pump by the number of cycles of the first pump;
(f) if the current ratio is greater than the desired ratio, the computer reducing the partial-operative voltage and outputting the partial-operative voltage to the second fluid regulator;
(g) if the current ratio is less than the desired ratio, the computer increasing the partial-operative voltage and outputting the partial-operative voltage to the second fluid regulator; and
(h) repeating steps d-h.

10. The method of dispensing plural component materials under pressure according to claim 9, wherein the computer is a programmable logic controller.

11. The method of dispensing plural component materials under pressure according to claim 9, wherein the inputting is performed on a keypad.

12. The method of dispensing plural component materials under pressure according to claim 9, wherein the inputting is performed on a keyboard.

13. The method of dispensing plural component materials under pressure according to claim 9, wherein the computer counting the number of cycles includes monitoring an input port, the input port electrically interfaced to a sensor associated with one of the pumps.

14. An apparatus for dispensing plural component materials under pressure having a first and a second component and a desired ratio between the components, the apparatus comprising:
a first pump means having an outlet and having an inlet connected to the first component;
a second pump means having an outlet and having an inlet connected to the second component;
a first driver means connected by a first shaft means to the first pump means;
a second driver means connected by a second shaft means to the second pump means;
a first sensor means coupled to the first shaft means and adapted to output a signal relational to a volume being pumped by the first pump means;
a second sensor means coupled to the second shaft means and adapted to output a signal relational to a volume being pumped by the second pump means;
a first fluid regulator means having an input, and output and a control, the first fluid regulator means input attached to the outlet of the first pump means;
a second fluid regulator means having an input, and output and a control, the second fluid regulator means input attached to the outlet of the second pump means;
a mix manifold means connected to the output of the first fluid regulator means and connected to the output of the second fluid regulator means for mixing the component materials;
a controller means electrically coupled to the first sensor means and electrically coupled to the second sensor means, the controller means adapted to determine an output volume of each pump means and adapted to adjust an output ratio of the components to approximate the desired ratio by controlling each of the fluid regulator means.

15. The apparatus for dispensing plural component materials of claim 14, wherein the controller means counts pulses from the sensor means to determine the output volume of each pump means.

16. The apparatus for dispensing plural component materials of claim 14, wherein each sensor means generates one or more pulses per stroke of the pump means to which it is coupled.

17. The apparatus for dispensing plural component materials of claim 14, wherein the controller means is electrically coupled to each of the fluid regulator means.

18. The apparatus for dispensing plural component materials of claim 14, wherein the controller means is electrically coupled to control two air pressure modulator means, each air pressure modulator means having an input coupled to a source of air pressure and an output coupled to one of the fluid regulator means for controlling the flow of components through the fluid regulator means.

19. The apparatus for dispensing plural component materials of claim 14, wherein each of the sensor means includes at least one magnet means affixed to one of the shaft means and an induction coil means electrically coupled to the controller means, the induction coil means in proximity to a travel path of the at least one magnet means.

20. The apparatus for dispensing plural component materials of claim 14, wherein each of the sensor means includes at least one optical interrupter means coupled to one of the shaft means, a light source means and a photo detector means, the photo detector means electrically coupled to the controller means, the light source means aiming at the photo detector means and the interrupter means passing between the light source means and the photo detector means so as to interrupt the light and generate an output pulse each time the interrupter means passes between the light source means and the photo detector means.

21. An apparatus for dispensing plural component materials under pressure having at least a first and a second component and a desired ratio between the components, the apparatus comprising:
a first and a second pump, each of the pumps having an outlet and having an inlet connected to one of the components;
a first and second driver, the first driver connected by a first shaft to the first pump forming a first driver-pump set and the second driver connected by a second shaft to the second pump forming a second driver-pump set;
a first sensor coupled to the first driver-pump set and a second sensor coupled to the second driver-pump set, each of the sensors outputting a signal relational to a volume being pumped by the driver-pump set to which the sensor is connected;
a fluid regulator each having an input, an output and a control, the input attached to the outlet of the first pump;
a mix manifold having a first input connected to the output of the fluid regulator and having a second input connected to the output of the second pump, the mix manifold for mixing the component materials;
a controller electrically coupled to the sensors, the controller adapted to determine an output volume of each pump and adapted to adjust an output ratio of the components to approximate the desired ratio by controlling the fluid regulator.

22. The apparatus for dispensing plural component materials of claim 21, wherein the controller is electrically coupled to the fluid regulator.

23. The apparatus for dispensing plural component materials of claim 21, wherein the controller is electrically coupled to control an air pressure modulator, the air pressure modulator having an input coupled to a source of air pressure and an output coupled to the fluid regulator for controlling the fluid regulator.

24. The apparatus for dispensing plural component materials of claim 1, wherein each of the sensors includes at least one magnet affixed to one of the shafts and an induction coil electrically coupled to the controller, the inductor coil in proximity to a travel path of the at least one magnet.

25. The apparatus for dispensing plural component materials of claim 1, wherein each of the sensors includes at least one optical interrupter coupled to one of the shafts, a light source and a photo detector, the photo detector electrically coupled to the controller, the light source aiming at the photo detector and the interrupter passing between the light source and the photo detector so as to interrupt the light and generate an output pulse each time the interrupter passes between the light source and the photo detector.
